(19) United States
(12) Patent Application Publication
(10) Pub. No.: US 2006/0251543 A1
(43) Pub. Date: Nov. 9, 2006

(54) Miniaturized gas sensors featuring electrical breakdown in the vicinity of carbon nanotube tips

(75) Inventors: Nikhil Koratkar, Troy, NY (US); Pulickel Ajayan, Troy, NY (US); Ashish Modi, Troy, NY (US); Eric Lass, Troy, NY (US)

Correspondence Address: FOLEY AND LARDNER LLP;SUITE 500, 3000 K STREET NW, WASHINGTON, DC, 20007, US

(73) Assignee: Rensselaer Polytechnic Institute

(21) Appl. No.: 10/540,112

(22) PCT Filed: Dec. 19, 2003
(86) PCT No.: PCT/US03/40665

§ 371 Date: Jun. 16, 2006

Related U.S. Application Data
(60) Provisional application No. 60/435,041, filed on Dec. 20, 2002.

(51) Int. Cl. G01N 27/00

(52) U.S. Cl. 422/98

(57) ABSTRACT

An ionization gas sensor includes a first electrode and a second electrode, such as cathode and anode electrodes. The second electrode is a carbon nanotube film having a carbon nanotube density such that the film behaves as a conducting sheet electrode. The sensor also includes a voltage source electrically connected to the first and to the second electrodes. The voltage source is adapted to generate an electric field near tips of carbon nanotubes in the carbon nanotube film which induces electrical breakdown of an analyte gas, which leads to a self-sustaining inter-electrode arc discharge

### CROSS-REFERENCE TO RELATED PATENT APPLICATIONS

This application claims priority to U.S. Provisional Application Ser. No. 60/435,041, filed Dec. 20, 2002, the disclosure of which is incorporated by reference herein in its entirety.

### BACKGROUND OF THE INVENTION

The present invention relates generally to the field of gas sensors and specifically to gas sensors featuring electrical breakdown in the vicinity of carbon nanotube tips.

Gas sensors operate by a variety of fundamentally different mechanisms. Ionization sensors work by fingerprinting the ionization characteristics of distinct gases. See for example the sensors described at www.ertresponse.com/sops/2114.pdf (1994) and www.srigc.com/FID.pdf (1998). However, such sensors are limited by their large bulky architecture, high power consumption and risky high-voltage operation.

Other sensors, such as solid state gas sensors, are based on semi-conducting metal oxides, silicon devices, organic materials and gas responsive polymers or ceramics. To achieve high chemical sensitivity, semi-conducting metal oxide sensors are operated at elevated temperatures (200 to 600° C.) in order to achieve the required chemical reactivity between gas molecules and the sensor material. This need for high temperature operation increases the device complexity and renders them unsuitable for real-time environmental monitoring. On the other hand, conducting polymers and organic semi-conductors are suitable for room temperature operation, but exhibit limited sensitivity, and are characterized by very high resistivity (sample resistance of greater than 10 giga ohms).

Carbon nanotube gas sensors have also been proposed. Most of these sensors are based on the chemical sensitivity of semi-conducting nanotubes. These sensors are based on a principle that an electrical conductance of semi-conducting carbon nanotubes changes sensitively at room temperature on exposure to several gases due to charge transfer between adsorbed gas molecules and nanotubes. See, Science 287, 1801-1804, Mar. 10, 2000; Science 287, 622-625, Jan. 28, 2000; H. Dai et al., “Carbon nanotube chemical and mechanical sensors”, 3rd International Workshop on Structural Health Monitoring, Stanford University, Calif., Sept. 11-14, 2001; IEEE Sensors 2, 82-88, April 2002; and Proc. of the IEEE International Microwave Symposium, Piscataway, N.J., Vol. 2, pp. 639-42, 2002.

Although the above gas sensors have a high sensitivity, they are limited by several factors, such as the inability to identify gases with low adsorption energies, poor diffusion kinetics or poor charge transfer with nanotubes. It is also challenging to use this technique to distinguish between gases or gas mixtures. Gases in different concentrations could produce the same net change in conductance as produced by a single pure gas. Nanotube conductance is also very sensitive to changes in environmental conditions (moisture, temperature, gas-flow velocity), and chemisorption could cause irreversible changes in nanotube conductivity.

A self-sustaining discharge gas sensor with a carbon nanotube cathode has also been proposed. X. Li, et al., 15^{th} Int'l Vacuum Microelectronics Conf. Proc. (2002 IVMC-IFES), Jul. 7-11 (2002), Lyon, France (http://ivmc2002.univ-lvon1.fr/Abstracts/EA_{—}020.pdf) It is noted that the listing of this article herein is not an admission that this article necessarily constitutes prior art against the present invention. The present inventors believe that this article describes a gas sensor based on Townsend Discharge principle, where carbon nanotubes, believed to be multi-walled carbon nanotubes are deposited on a rounded, metal cathode tip. The sensor also contains an anode electrode separate from the nanotube coated cathode tip. By measuring the ionization voltage and current between the anode and the cathode tip, the gas species and concentration, respectively, may be determined. Other gas sensors of this general type are described in C. Zhu et al, “Study of discharge gas sensor with carbon nanotube,” Proceedings of the 14th International Vacuum Microelectronics Conference, pp. 13-14, University of California, Davis, Aug. 13-16, 2001 and in D. Pinghu, and L. Baoming, “Study of a new gas sensor based on electrical conductance of gases in a high electric field,” Chinese Journal of Scientific Instrument 19, 3, 1998.

However, the present inventors believe that the discharge gas sensor described in the Li et al., article also suffers from several draw backs. First, the present inventors believe that the Li et al. sensor is adapted to determine the species and/or concentration of a pure gas analyte rather than the species and/or concentration of analyte gas or gases present in a gas mixture. Furthermore, the present inventors realized that the gas detection area and the nanotube density and size uniformity in the sensor of Li et al. are lower than desired because the nanotubes are formed on narrow, rounded tips. These draw backs may lead to poor or non-uniform gas sensing results.

### BRIEF SUMMARY OF THE INVENTION

An ionization gas sensor includes a first electrode and a second electrode, such as cathode and anode electrodes. The second electrode is a carbon nanotube film having a carbon nanotube density such that the film behaves as a conducting sheet electrode. The sensor also includes a voltage source electrically connected to the first and to the second electrodes. The voltage source is adapted to generate an electric field near tips of carbon nanotubes in the carbon nanotube film which induces electrical breakdown of an analyte gas, which leads to a self-sustaining inter-electrode arc discharge.

### BRIEF DESCRIPTION OF TEE DRAWINGS

FIG. 1A is a perspective view of the gas sensor of a preferred embodiment of the present invention.

FIG. 1B is a side-cross sectional view of the gas sensor of FIG. 1A.

FIG. 1C is an SEM micrograph of a vertically aligned multi-walled carbon nanotube film used as a sensor electrode.

FIGS. 2A and 2B are current-voltage curves showing various breakdown voltages measured by the sensor of the preferred embodiments of the present invention.

FIG. 3A is a plot of the effect of gas concentration on breakdown voltage measured by the sensor of the preferred embodiments of the present invention.

FIG. 3B is a plot of the effect of gas concentration on discharge current measured by the sensor of the preferred embodiments of the present invention.

FIG. 4A is a plot of the effect of electrode separation on breakdown voltage measured by the sensor of the preferred embodiments of the present invention.

FIG. 4B is a plot of the effect of analyte concentration of an analyte gas in a gas mixture on breakdown voltage measured by the sensor of the preferred embodiments of the present invention.

FIG. 4C is a plot of the effect of gas concentration on discharge current from a simulated sensor integrated with a gas chromatography device according to an alternative embodiment of the present invention.

FIG. 5 are micrograph of a SWNT electrode films according to an alternative embodiment of the present invention.

FIG. 6 is a side cross sectional view of a gas sensor incorporated into a micro-ionization chamber according to an-alternative embodiment of the present invention.

FIGS. 7A, 7B, 7C, 7D, 7E, 7F, 7G, 7H and 7I are a side cross sectional views of the steps in a method of making the sensor shown in FIG. 6.

### DETAILED DESCRIPTION OF THE PREFERRED EMBODIMENTS

Unless otherwise indicated, “a” or “an” means “one or more”.

The preferred embodiments of the present invention provide an ionization gas sensor that overcomes some of the limitations described in the previous section. The ionization microsensor uses the extremely high electric fields that are generated near nanotube tips as a means of inducing electrical breakdown of the analyte gas at relatively low voltages. The sensor may be used to determine the species and/or the concentration of a range of gases and gas mixtures the are broken down at the carbon nanotube tips.

The sensor contains an electrode comprising nanotubes that are formed in a shape of a film. The nanotubes in the film are densely packed and the inter-tube tunneling effects result in the aggregate nanotube film behaving like a conducting sheet electrode. Thus, the sensor includes a nanotube electrode with a high density and uniformity and a comparatively large sensing area. The nanotube electrode is preferably the anode electrode, which reduces the potential damage to the nanotubes in the electrode. The sharp tips of nanotubes generate very high electric fields at relatively low voltages, lowering breakdown voltages several-fold in comparison to traditional electrodes, and thereby enabling compact, battery-powered and safe operation of the sensor.

The sensor shows good sensitivity and selectivity, and is substantially unaffected by extraneous factors such as temperature, humidity, and gas flow. The simple, low-cost sensors can be used in a variety of applications, such as environmental monitoring, sensing in chemical processing plants, in material composition analysis and in gas detection for counter-terrorism.

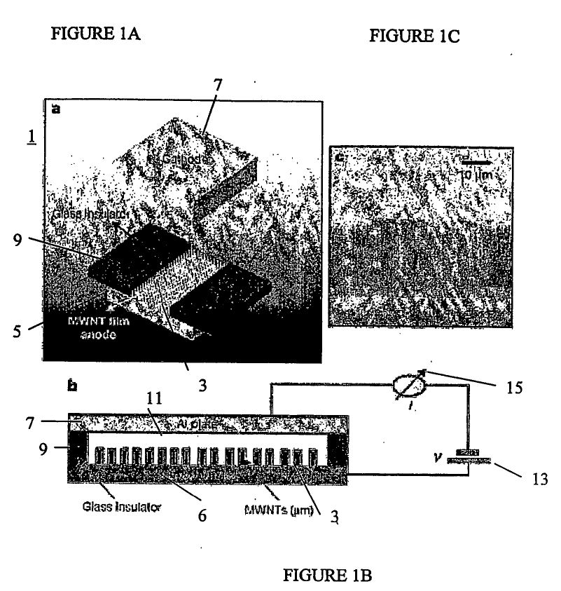

FIG. 1A shows a diagram of the component parts of the sensor 1 and FIG. 1B shows the configuration of the electrodes. The anode electrode 3 is a densely packed, aggregate nanotube film behaving like a conducting sheet electrode. This nanotube film is shown in FIG. 1C and comprises a multi-wall carbon nanotube (MWNT) Film. The nanotubes in the film are about 25-30 nm in diameter, having an about 10 nm wall thickness, about 30 μm long, with an about 50 nm average separation between nanotube centers.

It is preferred that the average separation between the nanotube centers in the densely packed film be below 300 nm, such as 40 to 100 nm, to allow the film to act as a conducting sheet electrode. In such a conducting sheet electrode, current is conducted laterally between adjacent electrodes. Thus, an electrical contact to the nanotubes may be made by placing a metal contact, such as an Al or Au contact, in contact with an upper surface of a portion of the nanotube film. Alternatively, the nanotube film may be grown on the metal contact layer 5, such as on an Au contact layer formed over a substrate 6.

Any suitable nanotube length may be used, such as 20 to 100 microns, for example. It is preferred that the length of the nanotubes in the film be substantially uniform, such as a length that is within 10% of an average length.

The MWNT film shown in FIG. 1C is grown by catalytic chemical vapor deposition (CVD) of a xylene-ferrocene mixture precursor on SiO₂ substrate in an Ar atmosphere at about 800° C. The substrate is exposed to vapor mixtures comprising xylenes (C₈H₁₀), a nanotube-forming precursor, and ferrocene (Fe(C₅H₅)₂), a nanotube catalyst, at about 600 to 1100° C., such as at about 800° C. However, other suitable source gases and temperatures may be used instead. Other substrate materials and layers, such as gold, silicon oxynitride, magnesium oxide, aluminum oxide or indium tin oxide may also be used to grow the nanotubes. Ferrocene may be dissolved in xylenes (which preferably contains different isomers) at concentrations of about 0.01 g/ml, the mixture pre-heated, co-evaporated and fed into the CVD chamber. Ferrocene preferably comprises 0.001 to 1 percent of the ferrocene/xylenes mixture. Prolonged growth in the temperature range of 600-1100° C., selectively produces patterns of densely packed multi-walled carbon nanotubes on the template.

Optionally, the as-grown nanotubes shown in FIG. 1C can then be incorporated into a polymer matrix to increase robustness of the sensor. Preferably, poly(dimethylsiloxane) polymer (PDMS) is used as a matrix material. However, other suitable polymer materials, such as polyesters, polyamides or polycarbonates may be used as a matrix instead. Furthermore, monomer and oligomer containing materials may also be used if these materials are polymerized to form a polymer matrix film prior to the peel apart step. A thin film of PDMS is spin coated onto the nanotube pattern or film. The polymer disperses into vacant areas in the nanotube array. The nanotube/polymer matrix is then cured for a suitable time, such as 24 hours at room temperature and under atmospheric conditions. The polymer material is coated to a thickness that is less than the length of the nanotubes in the nanotube film. This way, the nanotube tips protrude from the surface of the polymer matrix to act as an electrode. In case the polymer matrix material is used, the nanotubes may be grown on the electrical contact, such as a gold or other suitable metal contact.

The sensor also contains a cathode electrode 7. The cathode electrode is a conductive sheet, such as an Al sheet. Other suitable conductive materials may also be used. In an alternative embodiment of the present invention, the nanotube film is used as a cathode electrode while the non-nanotube conductive sheet is used as an anode electrode.

The electrodes 3, 7 are separated by an insulating spacer 9, such as a glass insulator. For example, a 180 micron thick spacer may be used. Other suitable insulating spacers may also be used. A gas detection volume 11 is formed between the electrodes. The analyte gas is provided into this volume through an inlet opening or conduit. The arc-discharge propagates between the electrodes through this detection volume.

The sensor is electrically connected to a voltage source 13 which provides a potential difference between the anode and cathode electrodes. Any suitable voltage source may be used, such as an electrochemical device, such as one or more batteries hooked up in series or a small fuel cell, or a power outlet (i.e., such as an outlet connected to a power grid or a generator that is adapted to provide a DC voltage). Preferably, an adjustable voltage source is used to provide a range of voltages between the electrodes. The sensor also contains a breakdown voltage measuring device, such as a volt meter, which may be integrated into the voltage source or positioned separately from the voltage source. The sensor is also preferably connected to a current measurement device 15, such as an ammeter, which measures the discharge current at various voltages. The ammeter may be integrated into the voltage source and/or the voltage measuring device, or positioned separately from the voltage source and voltage measuring device.

The gas sensor operates as follows. Controlled DC voltage is applied between the anode (vertically aligned MWNT film) and the cathode (Al sheet), which are separated by the glass insulator. Individual MWNTs within the film, owing to their nanometer scale tip radius of about 15 nm, create very high nonlinear electric fields near the tips. This hastens the breakdown process due to formation of a ‘corona’ or conducting filament of highly ionized gas that surrounds the MWNT tips. This corona promotes the formation of a powerful electron avalanche or plasma streamer that bridges the gap between the electrodes, and allows a self-sustaining inter electrode discharge to be created at relatively low voltages.

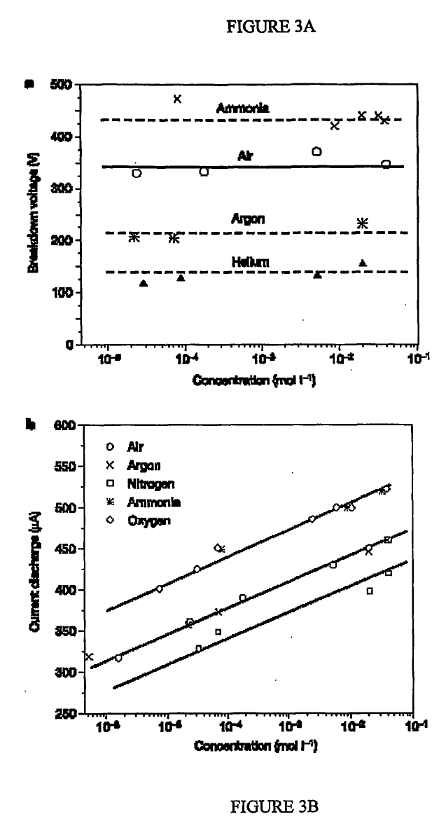

This technique may be used to identify unknown analyte gas species, either in a pure gas or in a gas mixture. The precise breakdown voltage provides the ‘fingerprint’ for the gas to be identified. It is well established that at constant temperature and pressure every gas has a unique breakdown electric field. Thus, for a fixed inter-electrode spacing, the breakdown voltage of each gas is unique and depends mainly on the electric field and is only weakly affected by concentration of the gas over a wide range of concentrations, as will described in more detail below with respect to FIG. 3A. Therefore, by simply monitoring the breakdown voltage of the gas, its identity can be established. These results are repeatable and are verified by testing several samples.

This arc-discharge technique may also be used to determine a concentration of a known or unknown pure gas analyte or of a known or unknown gas analyte in a mixture. The self-sustaining arc-discharge current generated at breakdown is a characteristic property of the number of gas molecules per unit volume that are available for conduction. This implies that by monitoring the self-sustaining discharge current generated at breakdown, the concentration of the known or unknown gas species can be established. Because the arc discharge technique does not involve adsorption/desorption of gases, the arc discharge ionization gas sensor displays a fast response and is not limited by considerations of reversibility.

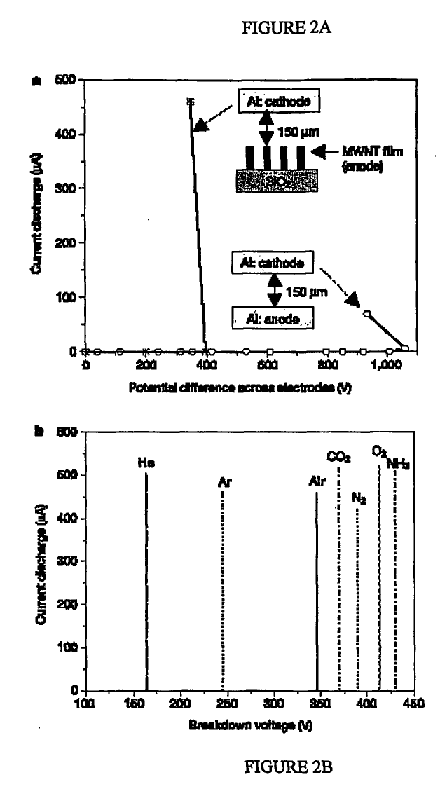

The following specific examples are presented for illustration of the preferred embodiments and should not be considered limiting on the scope of the invention. In a first example, the gas sensor schematically shown in FIG. 2A was first tested in air with anode-cathode separation of 150 μm. Continuous current discharge of 460 μA was generated at a breakdown voltage of air of 346V, as shown in the central portion of FIG. 2A. In a comparative example illustrated in the lower right portion of FIG. 2A, the test was repeated with metal anode and cathode electrodes (no nanotubes on either electrode), while still maintaining the electrode separation of 150 μm. In the comparative example, the breakdown voltage of air occurred at 960 V with current discharge of 69 μA. This shows that by the use of a gas sensor having a nanotube electrode, such as a MWNT film anode, the breakdown voltage of air can be reduced nearly 65%. The discharge current is also increased from 69 μA to 460 μA, which is an about 6-fold (566%) increase. This illustrates the high sensitivity of the sensor, where the discharge current at breakdown indicates concentration of the detected species, because a high discharge current enables detection of dilute concentrations of the unknown gas. Without wishing to be bound by a particular theory, the present inventors believe that the observed increase in discharge current is related to the high density of MWNTs in the film shown in FIG. 1C that constitute the electrode surface. The billions of aligned nanotubes covering the substrate produce a consistent nanometer-scale surface topology unobtainable for conventional planar electrodes or micromachined electron emitters. A significant number of these tubes are expected to participate in ionization, leading to a more extensive conduction path and consequently higher discharge current. The devices were robust, with no degradation observed after hours of operation.

In a second example, the ionization arc discharge gas sensor having a nanotube anode was used to detect or determine the identity of several gas species, such as helium, argon, nitrogen, oxygen, carbon dioxide, ammonia and air. The sensor was placed in an environmental chamber with electrical feed-through, and air was pumped out of the chamber to establish a high vacuum (10⁻⁴ torr). The gas to be identified was then released in a controlled fashion. Breakdown data were recorded over a wide range of gas concentrations (10⁻⁷ to 10⁻¹ mol per liter). FIG. 2B shows the breakdown voltages of NHₛ, CO₂, N2, O₂, Hₑ, Ar and air at room temperature (300° K) and at a chamber pressure of 760 torr (that is, a gas concentration of 4×10⁻² mol per liter). For all tests shown, the anode-cathode separation was maintained at 150 μm. As shown in FIG. 2B, each gas exhibits a distinct breakdown behavior. Helium shows the lowest (164 V) and ammonia shows the highest (430V) breakdown voltage.

In a third example, tests were conducted at reduced pressures to illustrate the effect of gas concentration on the results provided by the sensor. FIG. 3A shows the effect of concentration on the breakdown voltages of air, argon, helium and ammonia. As shown in FIG. 3A, the breakdown voltage does not vary significantly with gas pressure (i.e., less than a 20% variation, generally less than a 15% variation), where the pressure is proportional to concentration for a fixed chamber volume. Without wishing to be bound by a particular theory, the present inventors believe that the relative insensitivity of breakdown voltage to pressure is because breakdown behavior in this case is dominated by the highly nonlinear electric field near the nanotube tips, resulting in a pre-breakdown plasma that helps to bridge the electrode gap and reducing the sensitivity of breakdown voltage to gas pressure. But at very low gas concentrations (below 10⁻⁶ mol per liter), the breakdown voltage did increase as predicted by Paschen's law for uniform electric field, indicating a certain concentration threshold needed for the discharge to be self-sustaining. From the results of the second and third examples illustrated in FIGS. 2B and 3A, it is apparent that, for a fixed inter electrode spacing of the device, the breakdown voltage of each gas is unique and depends mainly on the electric field, being only weakly affected by concentration. This is valid over a wide range of concentration shown in FIG. 3A, such as from 10⁻⁵ to 10⁻¹ mol per liter. Therefore by monitoring the breakdown voltage of the gas, its identity can be established.

FIG. 3B shows the self-sustaining current discharge at breakdown for argon, nitrogen, oxygen, ammonia and air as a function of concentration. The discharge current varies logarithmically with concentration. This trend is valid over a wide range of gas concentrations, ranging from about 10⁻⁷ to about 10⁻¹ mol per liter. Thus, FIG. 3B shows that the self-sustaining discharge current generated at breakdown is a characteristic property of the number of gas molecules per unit volume that are available for conduction. For example, FIG. 3B indicates that for N₂, a current discharge of 328 μA corresponds to a concentration of 3.22×10⁻⁵ mol per liter. The discharge current increases logarithmically to about 420 μA as the N₂ concentration is increased to 4×10⁻² mol per liter. Therefore, the discharge current provides a convenient means to quantify the concentration of the species being detected. FIG. 3B also shows that no hysteresis is observed in the sensor response, even for species such as NH₃ and O₂ that are known to interact strongly with nanotube surfaces at room temperature.

In order to correlate the measured breakdown voltage and current discharge with particular gas species and concentrations, respectively, the sensor may be calibrated against a known gas species and/or against a known concentration in the actual sensor or in a reference sensor. For example, known gas species having known gas concentrations are provided into a reference sensor and the reference breakdown voltage and discharge current are recorded and stored in written form or electronically, such as in a computer memory or computer readable media. This data from the reference sensor is then provided to a computer, a processor circuit and/or a written chart that is to be used with any number of identical production sensors. When the breakdown voltage and/or a current discharge is measured in any of the production sensors for a given gas analyte, this measured voltage and/or current are compared to the respective reference voltage and/or current by a computer, processor circuit or the human operator of the sensor to determine the species and/or concentration of the gas analyte.

The breakdown process described above propagates through the formation of a positive or negative corona, depending on whether the nanotube film is configured as the anode or the cathode. For the experiments with the MWNT film as anode, the breakdown propagation mechanism is via the formation of a positive corona. The present inventors also conducted experiments in air with the MWNT film as cathode (negative corona). The tests indicate that the voltage at which breakdown is initiated is similar for both positive (350 V) and negative (330 V) corona. However, in negative corona, the breakdown voltage decreases to a lower value (˜280V) once breakdown is established. Without wishing to be bound by a particular theory, the present inventors believe that this effect occurs because once ionization is initiated in a negative corona, free electrons are repelled away from nanotube tips into the surrounding gas, triggering secondary ionizations that enable a self-propagating electron avalanche (a conducting path) to form at a lower electric field. Thus, forming the nanotubes on the anode is preferred (but not required) to forming nanotubes on the cathode, such as the nanotubes formed on a tip cathode in the sensor of Li et al., because it apparently reduces the damage to the nanotubes from the avalanche and provides a more accurate result.

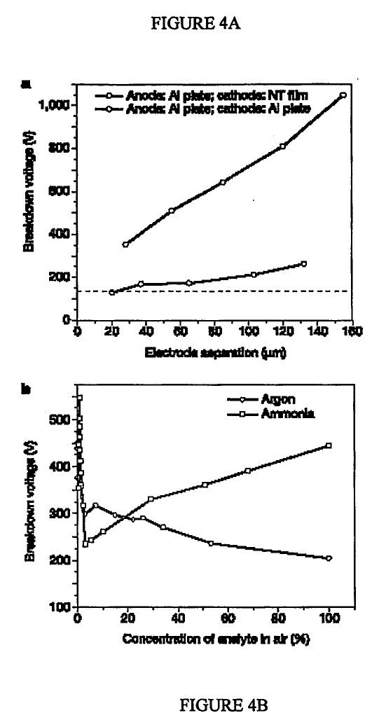

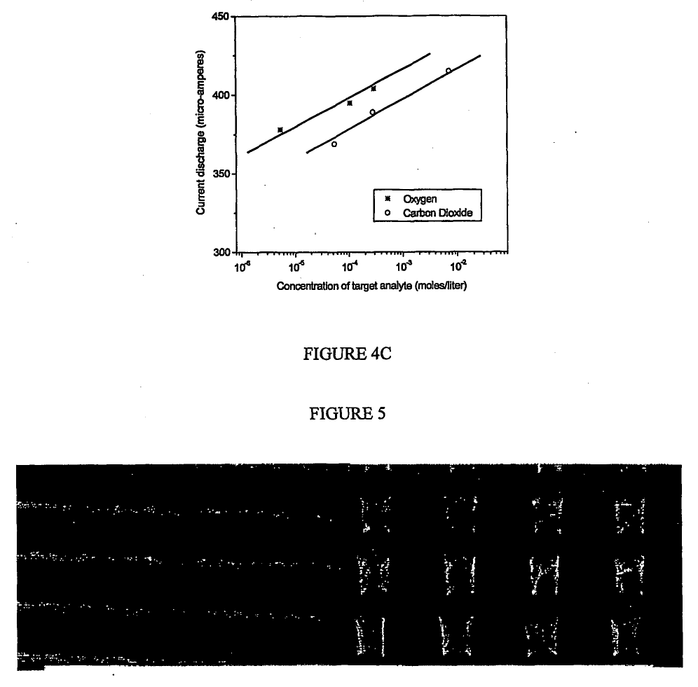

The breakdown voltage was found to become lower as the inter electrode spacing was reduced. This is expected, as reducing the electrode separation increases the electric field in the gap. FIG. 4A shows breakdown voltage as a function of electrode separation. Two cases are shown, one when both electrodes were made out of Al plates (upper line) and the other with the MWNT film as a cathode (lower line). For the Al cathode, breakdown voltages came down from 1,050 V at 150 μm separation to 354V at 28 μm separation. For the MWNT film cathode, breakdown voltages went down from 280 V (at 150 μm separation) to 130 V (at 25 μm separation). Voltages in this range can be easily obtained by connecting several suitable batteries in series, such as six 22.5V carbon-zinc (AAA) batteries, shown as a dashed line in FIG. 4B. Therefore, nanotube based arc discharge gas sensors may be formed as portable gas sensors which are not required to be plugged into a power outlet during operation.

The nanotube arc discharge or ionization sensor can be used to monitor gas mixtures without or without the direct use of a chromatography arrangement. In contrast, prior art ionization sensors, such as photo-ionization detectors (PID), flame-ionization detectors (FD) or electron-capture detectors (ECD) are not suitable for direct sensing of gas mixtures. These prior art detectors work in conjunction with a gas-chromatography set-up that separates the mixture into distinct bands that can then be qualitatively and quantitatively analyzed.

The fourth specific example illustrates the use of the nanotube ionization sensor to determine the species and/or concentration of analyte gas in a gas mixture. FIG. 4B shows the results for an argon air mixture (line with circles) with several different relative concentrations of the component gases. As expected, for over 50% Ar in the mixture, the breakdown voltage is nearly the same as that of pure Ar. As the relative concentration of Ar in the mixture is reduced, the breakdown voltage increases from about 250V (for 50% Ar) to about 300V (for 1% Ar). This is because air has a higher breakdown voltage than Ar, so the presence of air molecules tends to impede the breakdown of Ar. Below 1% concentration, the breakdown of Ar ceases and the breakdown voltage rises sharply to the value for pure air (about 350V). Similar results (detection limits of about 1%) were also obtained for detection of NH₃ in a mixture with air (FIG. 4B, line with squares). The breakdown voltage decreases with decreasing NH₃ concentration until about 1%. Below 1% concentration, the breakdown of ammonia ceases and the breakdown voltage rises sharply to the value for pure air (about 350V). These tests indicate that the nanotube ionization microsensor with proper calibration may be used for room-temperature detection of gases at the percentage level in mixtures with air with a fast response without using a gas chromatography device to separate the gases in the mixture. Application of the breakdown electric field results in a stable discharge within about 20 μs. Thus, the concentration and/or species of a certain gases in a gas mixture may be determined in less than 30 seconds, such as in less than 10 seconds, preferably in less than 1 second (if a computer is used to analyze the data). In contrast, the metal oxide sensors used in industry typically operate at 300-500° C. for detection of 1% NH₃ with a response time of about 1 minute. Conducting polymer sensors show detection limits of 1% for NH₃ at room temperature, but require about 10 minutes for sensing.

The nanotube ionization sensor can also be used in combination with a gas separation device, such as a gas chromatography device (i.e., as a detector in gas chromatographs), where sufficiently large analyte concentrations are available. The gas separation device is used to separate gases in a mixture according to the gas species and then to provide the different gas species into the sensor sequentially.

The fifth specific example illustrates the use and sensitivity range of a nanotube-chromatography sensor, using a simulated gas-chromatography test with He chosen as the mobile phase. The results indicate that, with appropriate design of the chromatography arrangement, including choice of mobile phase, stationary phase and process parameters, the sensor may be used for detection of analytes in the low p.p.m. range (about 25 p.p.m.). Compact, low-power nanotube ionization detectors coupled to miniature separation columns provide field-portable gas chromatographs that could be used during emergency response and counter-terrorism situations that require definitive identification of contaminants in near real-time.

During gas chromatography separation, the gas sample is transported through a separation column using an inert gas called the mobile phase. The separation columns are typically fused silica open tubular columns that can be tightly wound into coils for compactness and are designed to separate the target analyte by using a stationary phase that is coated to the inside of the chromatography column. Other suitable column materials and designs can also be used. The function of the mobile phase is to sweep the analyte mixture through the length of the column. Therefore, post-separation, the target will be in a mixture with the mobile phase. To simulate such an environment, the present inventors added trace amounts of CO₂ and O₂ in an inert, helium ambient maintained at a partial pressure of 16 torr. Helium was selected as the inert mobile phase since it has a very low breakdown voltage (about 160 V) and is therefore not expected to impede the breakdown of the target. FIG. 4C illustrates a plot of the effect of gas concentration on discharge current from a simulated sensor integrated with a gas chromatography device according to the fifth specific example. The line position for oxygen in FIG. 4C is similar to the line position for oxygen in FIG. 3B. Thus, example five confirms that the intrinsic breakdown behavior of the analyte is retained in presence of He for concentrations as low as 10⁻⁶ moles/liter, which corresponds to a relative concentration of 25 ppm in a sample mixture with air at room temperature and atmospheric pressure.

These results indicate that the nanotube ionization detector may replace traditional ionization detectors (such as PID, FID or ECD) in a conventional gas-chromatography architecture. In fact, the nanotube ionization detector provides several advantages over the FID, PID or ECD detectors that are routinely used in chromatography sensors. FID has poor selectivity and requires bulky and hazardous hydrogen storage tanks during operation, PID has a better selectivity but is limited to a small range of analytes, and ECD is hazardous because it contains radioactive electron emitters. In contrast, the nanotube sensor is compact, safe to use and requires low power to operate. Since every gas has a characteristic breakdown electric field, a gas chromatograph with the nanotube ionization detector could potentially be applied to a broad range of analytes with good selectivity, as illustrated in FIGS. 2, 3 and 4.

In a second embodiment of the present invention, the arc discharge or ionization gas sensor contains a single walled nanotube (SWNT) film electrode instead of a MWNT film electrode. The gas sensor with a MWNT electrode of the first embodiment can be used to detect the identity of an unknown gas and determine its concentration. However the voltage inputs needed to enable gas breakdown are in the range of 150-350 V. In order to provide battery-powered operation, it is preferred, but not required to bring the device operating voltages down to below 100 V. To achieve an ionization sensor operating at voltages below 100 V, a SWNT film is used as an anode or cathode electrode. The anode SWNT electrode is preferred.

SWNTs have much smaller diameters (about 0.5 to about 1 nm) than MWNTs (about 25 to 30 nm). Thus, the electric field in the vicinity of SWNT tips is expected to be far greater than in the vicinity MWNT tips because of the smaller dimensions (i.e., diameters) of the SWNTs. At a particular applied voltage, the electric field of carbon nanotube of similar length depends on the curvature of the nanotube, with over 30 times field enhancement predicted for SWNTs compared to MWNTs.

While it is difficult to grow vertically oriented SWNTs, horizontal networks of SWNTs can be grown between pre-patterned, nanotube template material locations on a substrate which does not facilitate SWNT growth. A template material is any material on which aligned nanotubes, such as SWNTs, grow preferentially, such as by CVD growth, compared to the substrate material. For example, the template material may comprise a metal, such as gold, deposited on silicon features or patterns (i.e. a silicon substrate or layer features or patterns).

FIG. 5 illustrates horizontally aligned SWNTs that are grown between bridges (left image) or pillars (right image) of silicon features on which a thin metal layer is deposited. These SWNT bridges or networks may be used as the sensor electrode. SWNT density can be varied by changing the growth parameters. Separation between the bridges can also be varied via the mask used for lithography. The SWNTs can be straightened, cut and manipulated using the Focused Ion beam (FIB) technique or other suitable nanoscale cutting techniques. The free ends or tips of separated but aligned SWNT are provided at the location of the cut, which function as the surface of the electrode of the sensor. When a voltage is applied across the electrodes (such as the metal coated silicon features in FIG. 5), the broken ends (tips) of the nanotubes are connected by highly non-linear electric lines of force that reduce the breakdown voltages.

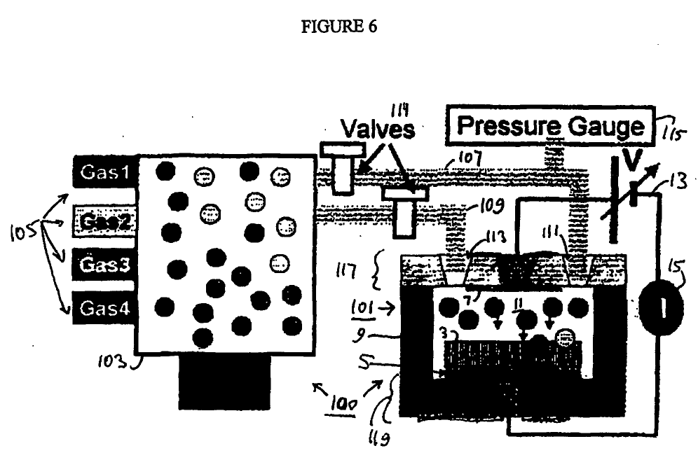

In a third embodiment of the present invention, the ionization or arc discharge nanotube gas sensor 1 is located in a system 100, where the sensor 1 is located in an ionization micro-chamber 101, as shown in FIG. 6. The system 100 comprises a gas reservoir 103 comprising one or more gas inlets 105. Inlet and outlet conduits 107, 109 connect the micro-chamber 101 with the gas reservoir 103 via inlet 111 and outlet 113 ports in the micro-chamber. Preferably the conduits 107, 109 are valved by valves 114. A pressure gage 115 may be used to monitor the gas pressure.

The micro-chamber 113 preferably comprises joined upper 117 and lower 119 portions with the gas testing volume 11 enclosed between the upper and lower portions. The upper and lower portions may comprise the same or different materials. For example, the upper portion may comprise a glass, plastic or ceramic plate with inlet and outlet ports. Preferably, the upper portion 117 comprises a photosensitive glass plate. A metal electrode 7, such as an Al layer is formed on the bottom surface of this upper portion facing the testing volume 11.

The lower portion 119 preferably comprises a semiconductor substrate 6. The upper surface of the substrate 11 contains a gold electrode 5, such as the anode electrode, with nanotubes 3 deposited thereon and extending into the testing volume. The inter-electrode gap (i.e., the testing volume) 11 is controlled by the thickness of the spacer 9 between the upper and lower portions. The upper and lower portions are preferably fabricated separately on two wafers or substrates that are bonded at the end.

For example, this sensor may be used to detect flammable gases. A very small quantity of the analyte gas or gas mixture is injected, isolated and tested in an ionization micro-chamber. All flammable species require a certain minimum concentration threshold of oxygen without which combustion cannot occur and the required oxygen concentration may not be available in the micro-chamber. Even if the flammable specie ignites, the control volume is limited to a very small test sample and this eliminates any safety concerns associated with testing of the flammable specie. Thus, the very small volume is a volume of an ignited flammable species that poses no safety problems. An exemplary volume is a volume of 10 to 50 nanoliters, such as 25 nanoliters for a 500 μm×500 μm×100 μm ionization micro-chamber.

The ionization micro-chamber is advantageous for several reasons. First, testing a small volume of gas improves fidelity and repeatability of results. Second, due to smaller control volume, the settling time and mixture diffusivity is better. Third, the ionization micro-chamber lends itself to system miniaturization. The device may be the size of a chip that includes the micro-chamber coupled to a controller that performs the impulse voltage scan and continuously monitors the current discharge responses. Thus, the entire sensor may comprise an integrated circuit, with the electronics provided into silicon or other semiconductor material used to form the micro-chamber.

Preferably, the ionization micro-chamber system is a MEMS (micro-electro-mechanical system) that is made by microfabrication techniques, which include thin film deposition and photo exposure patterning (such as etching of materials using an overlying photoresist mask formed by selective exposure and patterning, or etching selectively exposed regions in a photosensitive material). While semiconductor materials may be used to make the micro-chamber, non-semiconductor materials, such as glass, plastic, ceramic or quartz may be used instead of or in combination with semiconductor materials to fabricate the micro-chamber.

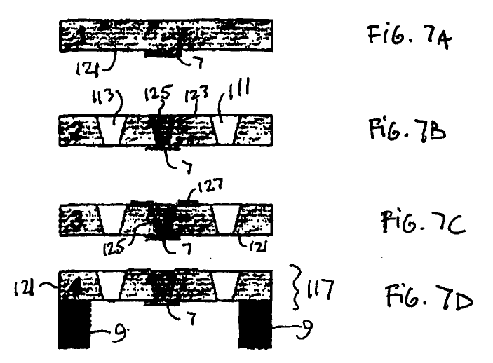

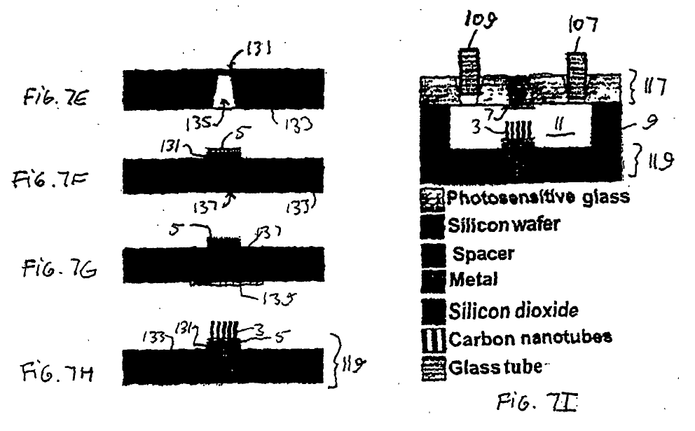

Custom microfabrication allows for flexibility in design, while miniaturization offers the opportunity to develop small-volume chambers (e.g. 25 nanoliters for a 500 μm×500 μm×100 μm chamber) with fast response time. Any suitable design with different chamber size, electrode size, electrode material and inter-electrode distance may be used. The MEMS microfabrication steps used to form the CNT-silicon-glass ionization micro-chamber are shown in FIGS. 7A-7I.

A metallic electrode layer such as an Al or other metal or metal alloy layer, is deposited by any suitable method, such as by electron beam evaporation, on an upper substrate 121, such as a photosensitive glass substrate. The electrode layer is then patterned by any suitable method, such as by forming a photoresist mask on the electrode layer and wet etching the exposed regions of the electrode layer or by a lift off method, to form the upper electrode 7 of the sensor, as shown in FIG. 7A. The photoresist mask is removed after forming the electrode. Preferably, this upper electrode comprises the cathode electrode. Of course if the sensor if turned up-side down, then this upper electrode becomes the lower electrode. Thus, the terms upper and lower, as used herein, are relative terms.

As shown in FIG. 7B, gas inlet/outlet ports 111, 113 and the via-trench 123 for the upper electrode are formed through the upper substrate 121. The trench exposes the upper surface of the upper electrode. If the upper substrate comprises a photosensitive glass, then the ports and trench may be formed in the substrate by selective radiation exposure, heat treatment and HF etch to define the gas inlet/outlet ports and the via-trench for the upper electrode. If the upper substrate comprises a material other than photosensitive glass, then the ports and trench may be formed by forming a photoresist mask on the substrate and etching the ports and the trench in the substrate using a suitable wet or dry etching medium. A contact fill material fills the trench such that it forms an electrical contact with the upper electrode.

As shown in FIG. 7C, metal contacts are made to the upper electrode. One or more contact pads 127 are formed on the opposite side of the upper substrate from the upper electrode. The contact fill material 125 in the trench electrically connects the upper electrode 7 with the contact pads 127. The contact pads and the contact fill material in the trench may comprise any suitable metal or metal alloy materials, such as Ni, Cu or Al alloys or pure metals. The contact fill material may be formed by metal electro-deposition to partially or fully fill the via-trench. The contact pad or pads and/or contact lines for the upper electrode may be formed by lift-off (i.e., forming a metal film on a photoresist pattern and then lifting off the photoresist pattern to leave the contact pad or pads on the upper substrate) or by forming a photoresist mask on a contact pad layer and etching the contact pad layer using the photoresist mask, which is subsequently removed.

As shown in FIG. 7D, a spacer 9 is formed on the same surface of the upper substrate as the upper electrode. Preferably, the spacer comprises a cylindrical spacer which encircles the upper electrode. The spacer may comprise any other suitable shape and any suitable material. For example, the spacer may be formed by deposition and patterning, such as SU-8 or AZ-4000 photoresist that is spin-coated at the desired thickness and patterned using W lithography. Alternatively the spacer may comprise a glass, ceramic or semiconductor material that is deposited on the upper or lower substrate. Furthermore, the spacer deposition step may be omitted, and the spacer may be formed by first etching a recess in a center portion of the upper substrate 121 and forming the upper electrode 7 in this recess. The cylindrical protrusion portion of the upper substrate surrounding the upper electrode acts as the spacer for desired inter-electrode distance. Thus, the gas detection volume 11 height is determined by the depth of the recess.

FIGS. 7E-7H illustrate the steps used to form the lower substrate and lower electrode of the sensor. The steps in FIGS. 7E-7H may be carried out before, after or at the same time as the steps illustrated in FIGS. 7A-D. FIG. 7E illustrates a formation of an etch stop layer 131 on the lower substrate 133. For example, the etch stop layer may comprise a silicon dioxide layer on a lower silicon substrate or wafer. For example, the etch stop layer be formed by deposition (e.g. by Low Pressure Chemical Vapor Deposition) and patterning (e.g. by Reactive Ion etching) of a thick (e.g. about 2 μm thick) SiO₂ film. Other etch stop materials, such as alumina and silicon nitride may also be used. A via trench 135 for the lower electrode is then formed through the lower substrate by any suitable method, such as by forming a photoresist mask on the bottom side of the lower substrate and KOH etching of the lower silicon substrate. The via trench etch stops on the etch stop layer, since KOH selectively etches silicon over silicon dioxide.

FIG. 7F illustrates the formation of a template material or layer 5 on the etch stop layer 131. The template material may be any material on which vertically oriented carbon nanotubes may be selectively formed compared to the substrate. The template material may be a conductive material, such as gold which can also act as a contact for the nanotube electrode that will be formed on the template material. The template material is preferably formed by deposition and patterning (e.g. by lift-off or by forming a photoresist mask on the template material followed by etching) of a metal film such as a gold film. The gold film will serve as seed layer for the selective nanotube growth.

FIG. 7F also illustrates the formation of a contact fill material 137 for the lower nanotube electrode. The etch stop layer is partially etched from below to expose the gold template material in the via trench 135. The silicon oxide etch stop layer may be selectively wet etched by a suitable etching medium, such as HF, which selectively etches the etch stop layer material compared to the substrate and the template material. A conductive contact fill material 137 is then deposited into the via trench 135 to fully or partially fill the via trench to make an electrical contact with the conductive template material. The fill material may comprise a Ni or Cu alloy or pure metal which is deposited on the exposed portion of the gold template in the via trench by electrodeposition. Next, one or more metallic contact pads and/or contact lines 139 are patterned on the bottom surface of the lower substrate as shown in FIG. 7G. The contact pad or pads and/or contact lines electrically contact the lower electrode through the metal fill material.

FIG. 7H illustrates the selective deposition of vertically aligned carbon nanotube film on the template material to form the lower electrode. Preferably, the lower electrode comprises the anode electrode. The nanotubes may be selectively deposited by CVD on the gold template 5 rather than on the exposed portions of the silicon substrate 133. If desired, the nanotube film may be photolithographically patterned.

In the final step shown in FIG. 71, the upper and lower substrates are bonded together, and gas tubing 107, 109 is sealed to the gas ports. Bonding techniques include adhesive bonding or anodic bonding depending on the approach used to make the spacer. After wafer bonding, the micro-chamber is wire bonded to a custom made carrier package which allows access of inlet and outlet gas tubing to the gas ports and electric access to the electrode pads on the bottom of the lower substrate. Existing chip-carriers may be adapted for these purposes. The micro-chamber may be optionally tested for gas permeability before using. Sealants or die coats may be added to the chamber if needed to improve sealing of the chamber.

As discussed above, the gas sensors of the preferred embodiments of the present invention provide very high non-linear electric fields near nanotube tips. The electric field in vicinity of the nanotube tips can be represented as E=V/R, where V is the applied voltage and R is the nanotube tip curvature. The extremely small tip curvature of nanotubes (about 15 nm for MWNTs and about 0.5 to about 1 nm for SWNTs) provides the high non-linear electric fields. This hastens the breakdown process due to formation of a “corona” or conducting filament of highly ionized gas that surrounds the nanotube tips. This promotes the formation of a powerful electron avalanche or plasma streamer that bridges the gap between the electrodes and allows for a self-sustaining inter-electrode arc discharge to be created at relatively low voltages. Lowering the device voltage is advantageous because it increases the safety of operation of the gas sensor and enables battery-powered operation. Battery power operation allows compact, affordable nano-electronic sensor development.

The gas sensor may identify the analyte gas species by monitoring the voltage at which the breakdown occurs and identify the analyte gas concentration by monitoring the self-sustaining discharge current. Since all gases display a characteristic breakdown response, a broad range of gases, including non-flammable and inert gases, such as Ar, can be detected, as opposed to conductivity measurements in some prior art gas sensors that are limited to gas species that exhibit adsorption and charge transfer with nanotubes. Since the method of operation of the gas sensor does not involve adsorption/desorption of gas species, the sensor displays fast response time and is not limited by considerations of reversibility. The sensor may also be used to determine the analyte gas species and/or concentration in gas mixtures by limiting the volume of gas affected by the ionization. This ensures that the gas being sensed does not get replenished as molecules breakdown and are ionized, allowing for continued sensing at higher voltages to detect the next gas in the mixture.

From the foregoing description, one skilled in the art can easily ascertain the essential characteristics of this invention, and without departing from the spirit and scope thereof, can male various changes and modifications of the invention to adapt it to various usages and conditions without undue experimentation. All patents, patent applications and publications cited herein are incorporated by reference in their entirety.

1. An ionization gas sensor, comprising:
a first electrode;
a second electrode comprising a carbon nanotube film; and
a voltage source electrically connected to the first and to the second electrodes, wherein the voltage source is adapted to generate an electric field near tips of carbon nanotubes in the carbon nanotube film which induces electrical breakdown of an analyte gas;
wherein the sensor is adapted to determine at least one of an analyte gas species and an analyte gas concentration for pure analyte gases and for analyte gases located in an analyte gas mixture.

2. An ionization gas sensor, comprising:
a first electrode;
a second electrode comprising a carbon nanotube film having a carbon nanotube density such that the film behaves as a conducting sheet electrode; and
a voltage source electrically connected to the first and to the second electrodes, wherein the voltage source is adapted to generate an electric field near tips of carbon nanotubes in the carbon nanotube film which induces electrical breakdown of an analyte gas.

3. An ionization gas sensor, comprising:
a first cathode electrode;
a second anode electrode comprising a carbon nanotube film; and
a voltage source electrically connected to the first and to the second electrodes, wherein the voltage source is adapted to generate an electric field near tips of carbon nanotubes in the carbon nanotube film which induces electrical breakdown of an analyte gas.

4. An ionization gas sensor, comprising:
a first electrode;
a second electrode comprising a single walled carbon nanotube film; and
a voltage source electrically connected to the first and to the second electrodes, wherein the voltage source is adapted to generate an electric field near tips of carbon nanotubes in the carbon nanotube film which induces electrical breakdown of an analyte gas.

5. An ionization gas sensor, comprising:
a first electrode;
a second electrode comprising a carbon nanotube film;
a voltage source electrically connected to the first and to the second electrodes, wherein the voltage source is adapted to generate an electric field near tips of carbon nanotubes in the carbon nanotube film which induces electrical breakdown of an analyte gas; and
a microfabricated ionization chamber containing the first and the second electrodes.

6. An ionization gas sensor, comprising:
a first electrode;
a second electrode comprising a carbon nanotube film; and
a battery powered voltage source electrically connected to the first and to the second electrodes, wherein the voltage source is adapted to generate an electric field near tips of carbon nanotubes in the carbon nanotube film which induces electrical breakdown of an analyte gas.

7. An ionization gas sensor, comprising:
a first electrode;
a second electrode comprising a carbon nanotube film;
a voltage source electrically connected to the first and to the second electrodes, wherein the voltage source is adapted to generate an electric field near tips of carbon nanotubes in the carbon nanotube film which induces electrical breakdown of an analyte gas; and
a gas chromatography device which is adapted to separate a gas mixture containing the analyte gas into constituent gases being provided into a gas detection volume between the first and the second electrodes.

8. The sensor of claim 1, further comprising a means for determining at least one of an analyte gas species and an analyte gas concentration for pure analyte gases and for analyte gases located in an analyte gas mixture.

9. The sensor of claim 1, further comprising a voltmeter which is adapted to detect a breakdown voltage of the analyte gas to determine the analyte gas species.

10. The sensor of claim 1, further comprising an ammeter which is adapted to detect a self-sustaining current discharge between the first and the second electrodes to determine a concentration of the analyte gas.

11. The sensor of claim 1, wherein the electric field near tips of carbon nanotubes in the carbon nanotube film which induces electrical breakdown of an analyte gas produces a corona or conducting filament of highly ionized gas that surrounds the nanotube tips, which promotes a formation of an electron avalanche or plasma streamer that bridges a gap between the first and the second electrodes and allows a self-sustaining inter-electrode arc discharge to be created.

12. The sensor of claim 1, wherein:
the first electrode comprises a sheet shaped metal or metal alloy cathode;
the second electrode comprises a sheet shaped carbon nanotube film anode with the carbon nanotubes aligned and extending toward the first electrode; and
a gas detection volume is formed between one surface of the first electrode and tips of the nanotubes of the second electrode.

13. The sensor of claim 1, wherein the carbon nanotubes comprise aligned multi-walled carbon nanotubes which extend toward the first electrode.

14. The sensor of claim 5, wherein the microfabricated ionization chamber comprises a gas impermeable chamber comprising:
an upper portion comprising:
an upper substrate containing the first electrode on an inner surface of the upper substrate;
at least one upper conductive contact pad on an outer surface of the upper substrate; and
a metal contact fill which is located in a via trench in the upper substrate, and which electrically connects the first electrode with the at least one upper contact pad;
a lower portion comprising:
a lower substrate;
a template material layer located over an inner surface of the lower substrate;
at least one conductive contact pad on an outer surface of the lower substrate; and
a metal contact fill which is located in a via trench in the lower substrate and which electrically connects the second electrode with the at least one lower contact pad; and
wherein the second electrode is located on the template material layer, such that a 10 to 50 nanoliter gas detection volume is formed between one surface of the first electrode and tips of the nanotubes of the second electrode.

15. The sensor of claim 1, wherein an average spacing between centers of adjacent nanotubes in the nanotube film is 40 to 100 nm.

16. A method of determining at least one of an analyte gas species and concentration, comprising:
providing the analyte gas into gas a detection volume located between a first electrode and a second electrode comprising a carbon nanotube film;
generating an electric field near tips of carbon nanotubes in the carbon nanotube film to induce an electrical breakdown of the analyte gas; and
determining at least one of an analyte gas species and an analyte gas concentration of the analyte gas irrespective of whether the analyte gas comprises a pure analyte gas or if the analyte gas is located in a gas mixture.

17. The method of claim 16, wherein the carbon nanotube film has a carbon nanotube density such that the film behaves as a conducting sheet electrode.

18. The method of claim 16, wherein the first electrode comprises a cathode electrode and the second electrode comprises an anode electrode.

19. The method of claim 16, wherein:
the first electrode comprises a sheet shaped metal or metal alloy cathode;
the second electrode comprises a sheet shaped carbon nanotube film anode with the carbon nanotubes aligned and extending toward the first electrode;
the gas detection volume is formed between one surface of the first electrode and tips of the nanotubes of the second electrode; and
the carbon nanotubes comprise single walled or multi-walled carbon nanotubes.

20. The method of claim 16, wherein:
the step of providing an analyte gas comprising providing the analyte gas into a gas impermeable microfabricated ionization chamber through a gas inlet port; and
the gas detection volume of the chamber is 10 to 50 nanoliters.

21. The method of claim 16, further comprising providing a voltage between the first and the second electrodes from a battery powered power source to generate the electric field near the tips of carbon nanotubes.

22. The method of claim 21, wherein the voltage is 130 V or less.

23. The method of claim 16, further comprising separating a gas mixture containing the analyte gas into constituent gases, and sequentially providing the constituent gases into the gas detection volume.

24. The method of claim 16, wherein the step of determining the analyte gas species comprises measuring a breakdown voltage of the analyte gas and determining the analyte gas species from the measured breakdown voltage.

25. The method of claim 16, wherein the step of determining the analyte gas concentration comprises measuring a self-sustaining current discharge between the first and the second electrodes and determining the analyte gas concentration from the measured current.

26. The method of claim 16, wherein the electric field near the tips of carbon nanotubes in the carbon nanotube film which induces electrical breakdown of the analyte gas produces a corona or conducting filament of highly ionized gas that surrounds the nanotube tips, which promotes a formation of an electron avalanche or plasma streamer that bridges the gas detection volume between the first and the second electrodes and allows a self-sustaining inter-electrode arc discharge to be created.

27. A method of making a microfabricated ionization chamber for an ionization gas sensor, comprising:
providing an first substrate;
forming a first electrode on an inner surface of the first substrate;
forming a first via trench exposing the first electrode and gas inlet and outlet ports through the first substrate;
filling the first via trench with a first metal contact fill;
forming at least one first conductive contact pad on an outer surface of the first substrate and in contact with the first metal contact fill;
providing a second substrate;
forming a template material layer over an inner surface of the second substrate;
forming a second via trench through the second substrate exposing the template material;
filling the second via trench with a second metal contact fill;
forming at least one second conductive contact pad on an outer surface of the second substrate and in contact with the second metal contact fill;
selectively growing a carbon nanotube film on the template material layer using selective CVD to form a second electrode; and
attaching the first substrate to the second substrate to form a gas detection volume between the first and the second electrodes.

28. The method of claim 27, further comprising:
forming an etch'stop layer on an inner surface of the second substrate; and
forming a spacer between the first and second substrates.

29. The method of claim 28, wherein:
the step of forming the template material layer comprises forming the template material layer on the etch stop layer; and
the step of forming the second via trench comprises etching the second via trench through the second substrate stopping on the etch stop layer using a first etching medium, and further etching the via trench through the etch stop layer to expose the template material using a second etching medium different from the first etching medium.

30. The method of claim 29, wherein:
the first substrate comprises a photosensitive glass plate;
the step of forming the first via trench and the ports comprises selectively exposing regions in the first substrate and selectively etching the exposed regions;
the step of forming the first electrode comprises photolithgraphically patterning a first electrode layer;
the template material comprises a gold template material;
the step of selectively growing the carbon nanotube film comprises selectively growing a multi-walled carbon nanotube film which behaves as a conducting sheet electrode from a vapor mixture comprising xylenes and ferrocene; and
the gas detection volume is 10 to 50 nanoliters.
